(19) United States
(12) Patent Application Publication
(10) Pub. No.: US 2012/0327214 A1
(43) Pub. Date: Dec. 27, 2012

(54) SYSTEM AND METHOD FOR IMAGE CALIBRATION

(75) Inventor: Gregory J. McENTYRE, Torrance, CA (US)

(73) Assignee: HNJ Solutions, Inc., Torrance, CA (US)

(21) Appl. No.: 13/165,687

(22) Filed: Jun. 21, 2011

(51) Int. Cl. H04N 17/00; H04N 7/18

(52) U.S. Cl. 348/86; 348/E07.085

(57) ABSTRACT

The present invention discloses a system for smart camera image calibration, comprising a calibration card, a size marking on the calibration card, and a calibration image on the calibration card. A method for smart camera image calibration comprises calibrating a vision system to a size marking, capturing a calibration verification image, and verifying the calibration verification image based on the size marking. A smart camera calibration system comprises a vision system, a first calibration parameter programmed into the vision system, a calibration card comprising a size marking, and a calibration image, wherein the calibration image is shown on the calibration card and in the vision system, wherein the calibration image substantially corresponds to at least some portion of a product, and wherein the size marking does not bear similarity to the at least some portion of the product.

### BACKGROUND OF THE INVENTION

1. Field of Invention

This invention relates to vision systems, in particular, to machine vision image calibration cards for inspection of products in automated mass manufacturing applications.

2. Description of the Related Art

Machine vision systems, including smart cameras, are known in the related art. Some vendors include: Keyence, Cognex, DVT (which was acquired by Cognex), Matrox, and Omron, among others. Machine vision systems are often used to inspect products for defects in mass manufacturing industrial environments. However, configuring the machine vision system can be difficult when a particular product requires customized vision system applications to be developed to inspect for specific defects in a product during mass manufacturing on an automated basis.

Calibration targets are also known in the related art. Many conventional calibration targets often have only dots or a checkerboard pattern. Dots alone, or a checkerboard alone, are insufficient to calibrate measurement size simultaneously with the target size of a vision system application, such as a product or component which is to be verified for correct dimensions. Further, calibration targets alone do not provide a way to measure or prepare a vision system solution for multiple deployments or for remote diagnosis. Conventional calibration targets are not made for industrial environments. Conventional calibration targets are made of a wide range of materials. Some known examples include glass, paper, and mylar. Conventional glass calibration targets suffer from problems such as reflectivity causing abnormalities in image calibration or detection, transparency, breakability, and are not a convenient size. Transparent and reflective characteristics produce lighting problems during imaging. Calibration targets made of paper or mylar are typically thin and do not maintain shape when laid upon a non-flat surface.

It can be seen, then, that there is a need in the art for a vision system calibration card which is convenient, durable for industrial environments, stays relatively flat when laid upon on a non-flat surface, easy to calibrate without changing lighting conditions, cleanable, and capable of being reused to calibrate after time lapse resulting in changed manufacturing environment such as changed lighting, dust, dirt, oil, or moisture. It can also be seen that there is a need to enhance image calibration simultaneously between a vision system application target and a calibration grid. Furthermore, it can be seen that there is a need to provide a quality measurement tool capable of supporting various quality standards for manufacturers, such as ISO, Six Sigma, or NIST traceability. Finally, it can be seen that there is a need to address any combination of these problems.

### SUMMARY OF THE INVENTION

To minimize the limitations in the prior art, and to minimize other limitations that will become apparent upon reading and understanding the present specification, the present invention discloses a calibration system comprising a calibration card, a size marking on the calibration card, and a calibration image on the calibration card where the calibration image corresponds to a product image. Further disclosed is a method for smart camera image calibration comprising calibrating a vision system to a size marking, capturing a calibration verification image, and verifying the calibration verification image based on the size marking.

The description of the preferred embodiments is to be understood as non-limiting examples of the present invention. The true scope of the invention is to be understood by the claims and not limited by the preferred embodiments.

An object of the present invention is to provide a system which is capable of simultaneous calibration of sizing units of measure and a target application.

An object of the present invention is to provide a durable, industrial class calibration card which can be reused to calibrate product-specific manufacturing vision systems.

An object of the present invention is to calibrate more closely to a known focal point, where the distance between the lens and target is substantially the same as the distance between the lens and the calibration card.

An object of the present invention is to provide an easy method to calibrate size in the real world based on known size markings, and to calibrate a product image without moving the calibration card or changing the focal point.

### BRIEF DESCRIPTION OF THE DRAWINGS

Referring now to the drawings in which like reference numbers represent corresponding parts throughout:

FIG. 1 illustrates a flat front view of a preferred embodiment of the present invention;

FIG. 2 is a detailed view of a possible embodiment of the present invention showing an orientation indicator;

FIG. 3 is a front view of a possible embodiment of the present invention; FIG. 4 is a schematic diagram of a possible embodiment of the present invention;

FIG. 5 is a method diagram of a possible embodiment of the present invention;

FIG. 6 is an angled view of a possible embodiment of the present invention;

FIG. 7 is a lens-distorted view of a possible embodiment of the present invention;

FIG. 8 is a front view of a possible embodiment of the present invention with concentric circles;

FIG. 8A is a possible embodiment of the present invention with product image 800; and

FIG. 9 is a front view of a possible embodiment of the present invention with concentric rectangles.

### DETAILED DESCRIPTION OF THE PREFERRED EMBODIMENTS

In the following description of the preferred embodiments, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

References throughout the specification to “a possible embodiment,” “a preferred embodiment,” “some embodiments,” “an embodiment,” and like reference to “embodiment” are non-limiting examples to aid in understanding an element, function, way, result, means, structure, aspect, and/or benefit of the present invention. An “embodiment” provides that there is one or more embodiments that can involve the given element or aspect of the invention. Thus, multiple instances of “an embodiment” and like reference do not necessarily refer to the same embodiment.

References to the following shall be understood throughout the specification:

“Calibrate” shall refer to measuring against a standard. Non-limiting examples can include size marking 102 and calibration verification image 300.

“Mark” when used in reference to calibration card 100 shall be understood to refer to etched, laser-etched, printed, anodized, lithographed, or any combination thereof, to provide differentiable contrast against color, gradient, or surface of underlying material.

“Substrate” when used in reference to calibration card 100 shall be understood to refer to underlying material upon which a mark can be made.

“Product” or product image 800 when used in reference to a product can include a whole product, a part of a product, component, label, or any other object which is or can be viewed by a vision system.

### Specifics of the Invention

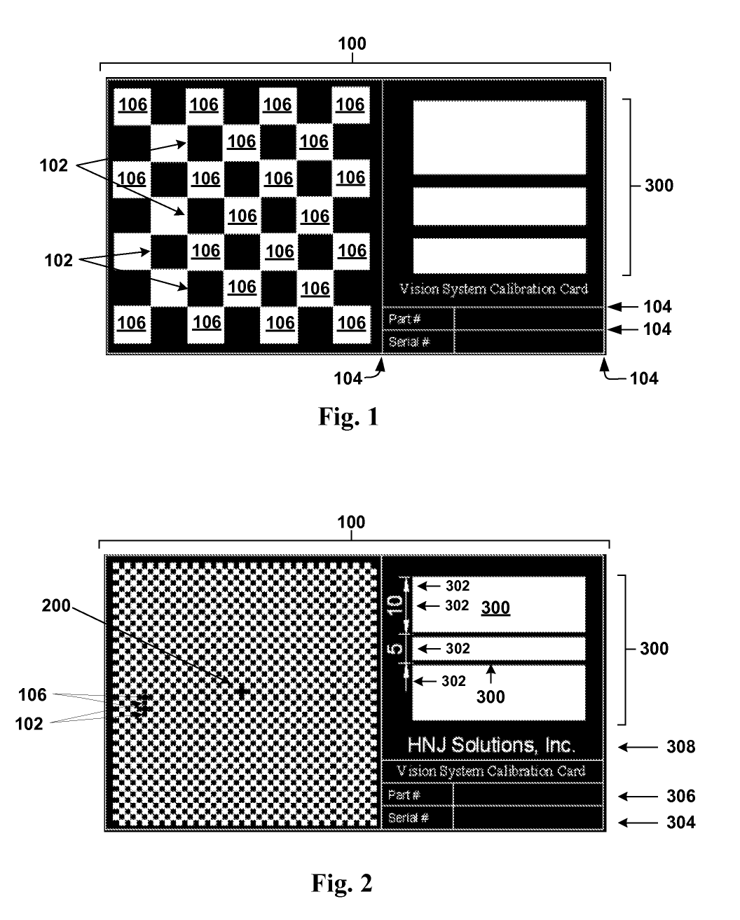

FIG. 1 illustrates a flat front view of a preferred embodiment of the present invention.

Calibration card 100 is shown in FIG. 1, with size marking 102, frame marking 104, space gap 106 shown between size markings 102, and calibration verification image 300.

Calibration card 100 can be a rigid surface, metal or non-metal. Calibration card 100 can provide an underlying substrate calibration card 100. In most preferred embodiments, calibration card 100 can be a thin, business card-sized dark metallic hard-anodized aluminum substrate with bright contrasting laser-etched markings. A benefit of calibration card 100 can be to provide simultaneous calibration of machine vision systems as to sizing as well as application-specific specification to scale, while helping to account for varying application-to-application manufacturing environment variables. Another benefit of calibration card 100 can be to provide a medium of calibration substantially at the focal plane such that when the product passes by the view from vision system 402, calibration is substantially obtained within relative degrees of tolerance. A benefit of calibration card 100 in rigid embodiments can be to maintain form in non-flat surfaces, or when card 100 stands at an angle or vertically in front of vision system 402 so as not to lose its shape. By way of non-limiting illustration, calibration card 100 can include: paper, wood, metal, plastic, metal alloy, or any combination thereof. In experimentation, it was hypothesized that laser etching on any metal might provide sufficient contrast for calibration. However, it was found that an anodized aluminum substrate provided higher contrast and thus made it easier to define clearer calibration measurements.

In experimentation, it was found that a soft-anodized aluminum substrate resulted in yellowing of markings upon calibration card 100. After further experimentation, a hard-anodized process can help create a more consistent surface on calibration card 100 for subsequent marking. After experimentation with paper-based prototypes, calibration card 100 of the present invention was found to be far more durable than paper, which is not as easily reused due to deformation, crumpling, warping, or other problems. Glass substrates present further difficulties because of their mass and thickness and are thus less preferred material for calibration card 100. Since conventional vision systems in the related art remain still, in a fixed position, calibrating an image at the wrong focal position can result from overly-thick substrates such as glass, thus reducing calibration accuracy or invalidating the calibration. Therefore, calibration card 100 is preferably a thin aluminum card. Benefits of preferred embodiments of calibration card 100 can be multifold: lightweight, pocket or wallet-sized, cost-effective, conveniently marked, reusable, high contrast, and rigid. A benefit of calibration card 100 in thin embodiments can be to reduce focal inaccuracy of a calibration target.

Size marking 102 can be shown on card 100. Size marking 102 can be a standard, uniform size dimension or a plurality of such dimensions. Size marking 102 can be, to provide non-limiting illustrations: a dot, square, rectangle, triangle, grid, geometric shape, or a pattern or combination thereof. Size marking 102 can be a single such marking, or a plurality thereof. In a preferred embodiment, size marking 102 can be a one-millimeter square. In most preferred embodiments, size marking 102 can be in a checkerboard pattern. In a preferred embodiment, size marking 102 can be an anodized marking on a metal surface. A benefit of size marking 102 can be to provide a basis of measurement, which can aid in obtaining proof of calibration via calibration verification image 300. By way of non-limiting illustration, size marking 102 can help to scale the imaging calculations in vision system 402, thus allowing for more accurate calibration of an image when subsequently used in a production quality checking or inspection via the calibrated vision system 402. Plurality of size markings 102 can be a repetitive pattern of size markings 102. A benefit of plurality of size markings 102 can be to provide definition of size measurement over a two-dimensional plane or over three-dimensions. There can be more than one type of size marking 102; size markings 102 need not be uniform, but in most preferred embodiments, size markings 102 are substantially uniform. A benefit of substantially uniform size markings 102 is to provide a basis for determining skew in a vision system 402 due to image warping through a focal lens, and to thus reduce errors due to warping, when inspecting a product on a manufacturing line after calibration is performed. Size markings 102 need not have orientation indicator 102.

Frame marking 104 can be a line or series of lines marked on calibration card 100 to show a space wherein any other marking can be made. A benefit of frame marking 104 can be to compartmentalize areas on calibration card 100.

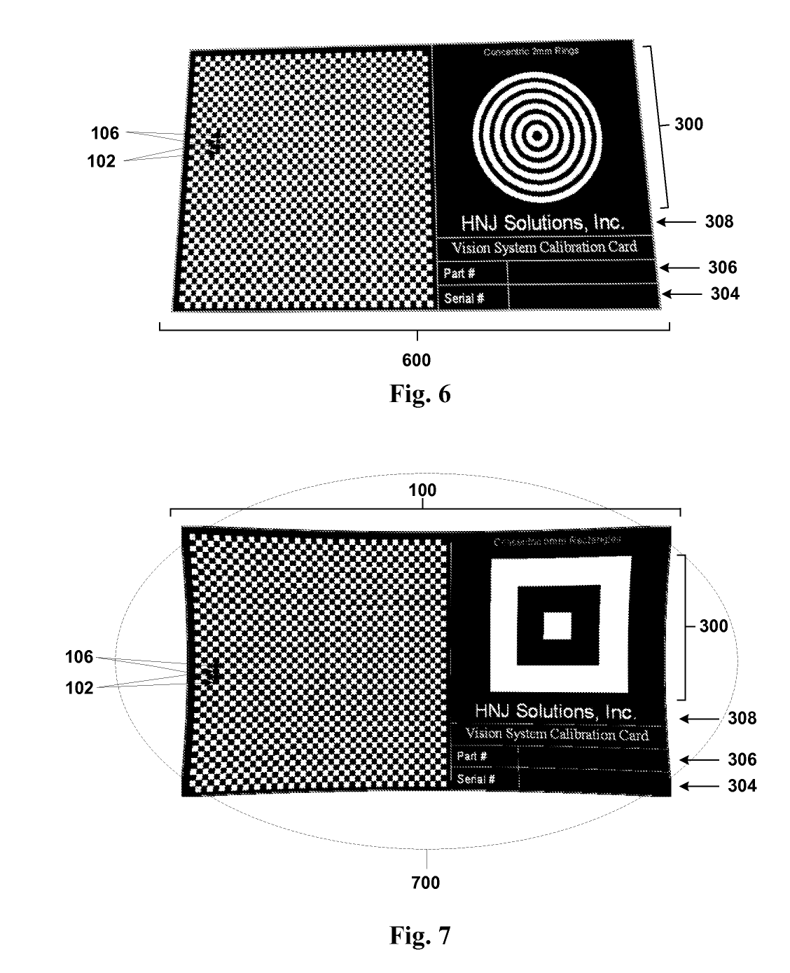

Space gap 106 can be provided between size markings 102. Space gap 106 can provide consistency across calibration card 100. When calibration card 100 is angled (FIG. 6) in relation to vision system 402, size markings 102 and space gap 106 have relative differential sizes in relation to vision system 402, and thus can be correctable in vision system 402.

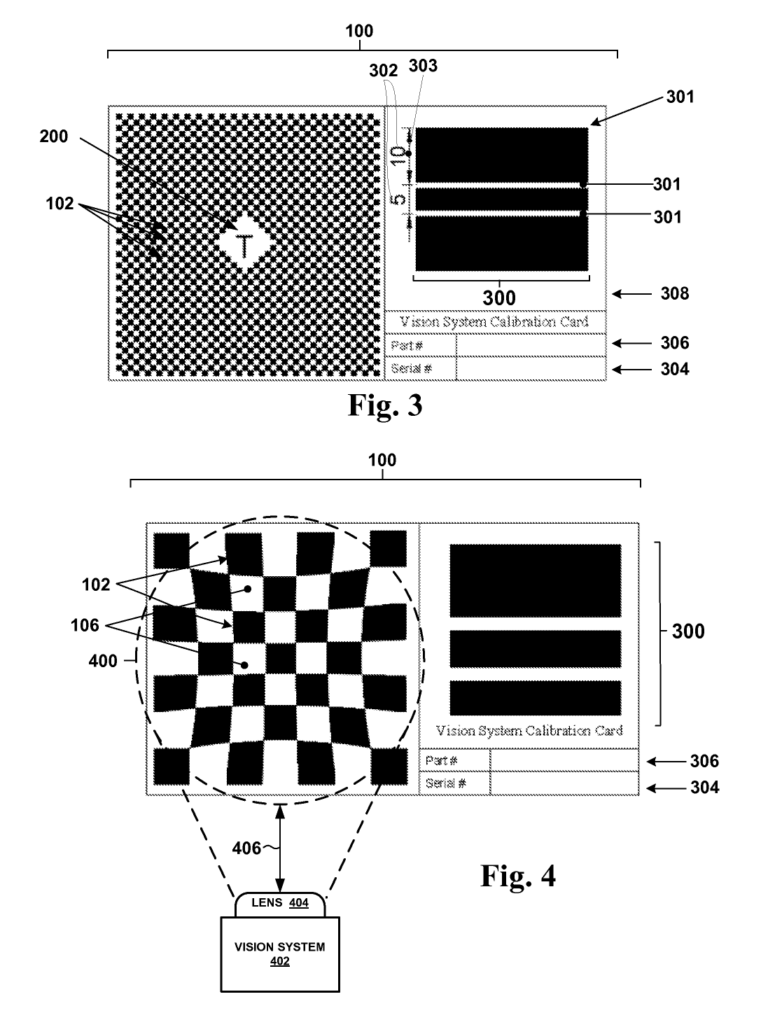

FIG. 2 is a detailed view of a possible embodiment of the present invention showing an orientation indicator.

Calibration card 100 is shown in FIG. 2 with plurality of size markings 102, space gap 106, orientation indicator 200, calibration verification image 300, measurement indicator 302, serial number 304, and part identifier 306, and vendor information 308.

Orientation indicator 200 can indicate direction, such as an x-axis, y-axis, or in embodiments indicating three dimensions, a z-axis. By way of non-limiting illustration, orientation indicator can be crosshairs, intersecting lines, rectangles, arrows, compass rose, crossing lines, elongated portions in the shape of a letter “T”, the letter “X”, or any other shape with more than one vector. In most preferred embodiments, orientation indicator 200 can be positioned roughly in the center of plurality of size markings 102. A benefit of central positioning of orientation indicator 200 can be to facilitate obtaining orientation via vision system 402 through a less-distorted portion of the lens of vision system 402. Orientation indicator 200 can have a background. In some possible embodiments, orientation indicator can be provided centrally to a plurality of size markings 102.

FIG. 3 is a front view of a possible embodiment of the present invention.

Calibration verification image 300 is in FIG. 3, with calibration card 100, size marking 102, orientation indicator 200, measurement indicator 302, serial number 304, component identifier 306, and vendor information 308.

Calibration verification image 300 refers to verifying that calibration was done correctly. Calibration verification image 300 can be simultaneously displayed with size marking 102 on calibration card 100. In most preferred embodiments, calibration verification image 300 can be an image with known dimensions. If the product to be viewed is large, then the card 100 has to be large enough to accommodate the product's corresponding calibration verification image 300. The size of calibration verification image 300 can correspond to the size of a product drawn to scale as seen in a two-dimensional view. “Drawn to scale” can refer to calibration verification image 300 being drawn to conform to size marking 102. Thus, by way of non-limiting illustration, a 1 mm line should match a 1 mm calibration grid previously calibrated via size marking 102. Further, calibration verification image 300 can be processed by vision system 402 after size marking 102. A non-limiting example of calibration verification image 300 can be a pair of 1 mm lines spaced 5 mm apart from the middle of the line. By way of non-limiting illustration, calibration verification image 300 can correspond to a bar code, data matrix, or any physical shape, image, design, product image 800, component image, vision system application inspection, a line, plurality of lines, spaces, series of spaces, or any combination or equivalent thereof. Calibration verification image 300 can be seen by vision system 402. Calibration image is not size marking 102. In some embodiments, where calibration verification image 300 comprises a line, the line can be straight, curved, jagged, irregular, discontinuous, or otherwise. By way of non-limiting illustration, a dot in calibration verification image 300 can be a relatively non-linear mark, whether elliptical, circular, or an irregular shape, a jagged shape, or a round shape. Calibration verification image 300 can have a line with an inward edge such that at least one outer edge of the line matches a product dimension. In some possible embodiments, calibration verification image 300 can have an inward edge which matches a product dimension. Calibration verification image 300 can be drawn to scale in most preferred embodiments. In some embodiments, a benefit of not drawing image to scale is to allow at least one mark on calibration card 100 to compensate for the thickness of the mark. By way of non-limiting illustration, in cases where calibration verification image 300 comprises a line, a 20 micron laser etching drawn at the middle of the line can leave 10 microns to either side of the mark. In some possible embodiments, calibration verification image 300 can be a test pattern with a defective product image 800 to allow vision system 402 to test whether a defective product will be likely to be detected, based on the fail test scenario. Calibration verification image 300 can show at least some portion of a product, and need not show the entire product. A benefit of showing only part of a product via calibration verification image 300 can be to facilitate inspection for defects based on an earlier calibration, since defects can be designed to be detected for, at isolated portions of a product, and thus calibration verification image 300 corresponding to part of a product can provide a benefit of checking for a specific type of defect, or multiple types of defects on a specific portion of a product. A non-limiting illustration of calibration verification image 300 and its corresponding product can be a label and its orientation on a package, which can be inspected via vision system 402 by two parallel lines calibrated via calibration card 100 with corresponding calibration verification image 300 showing a line with distance therebetween (FIG. 1). Thus, different parts can be inspected using different embodiments of the present invention. A benefit of the present invention can be to provide quick reference to a combination of calibration verification image 300, measurement indicator 302, serial number 304, and part identifier 306 to easily repeat calibration according to specified size markings 102 at a later time. Since vision systems are subject to degradation, such as oil from fingerprints, water, particles, camera movement, and change in other conditions typical of a manufacturing environment, the present invention can aid in repeatable calibration, and thus can help quickly correct a degraded vision system inspection system without the need for repeated expensive consultation. Unlike conventional calibration targets, calibration verification image 300 of the present invention can be product-specific. In a possible embodiment, calibration verification image 300 can be on the reverse side of card 100. A benefit of having calibration verification image 300 on card 100 is to provide a conveniently accessible golden standard by which to immediately check, after size calibration, whether calibration is correct. Such standard can be useful in situations where the product, label, or component is associated with a known two-dimensional view of the product. The two-dimensional view is used since three-dimensional views are “flattened” partly by the image received in the lens, and partly by correcting for skew, distortion, etc. The present invention is not limited in application to any particular industry. In some embodiments where calibration verification image 300 is used in a semiconductor application, calibration verification image 300 can be an image of a chip, wafer, connection, or other electronic component which is the target product to be inspected by vision system 402.

Geometric indicator 301 can be shown on calibration card 100. Calibration verification image 300 can comprise geometric indicator 301. Variations of geometric indicators are shown in FIG. 3, illustrating some non-limiting examples of lines, arrows, arrow lines with terminating ends, and rectangles. In many embodiments, geometric indicator 301 can aid in describing the shape of an object to be calibrated by vision system 402, where measurement indicator 302 is imprecise.

Measurement indicator 302 can be shown on calibration card 100 as part of calibration verification image 300. Measurement indicator 302 can be a line, a number, an arrow, a line with an arrow, a first line 303 with a second line 305 perpendicular to first line 303 to indicate a terminating end 307, a number with a pair of arrows 308 terminating the first line, a unit of measure, or any combination thereof. FIG. 3 shows non-limiting examples of measurement indicator being a number with accompanying line with double arrows. In some possible embodiments, units of measure can be omitted from measurement indicator.

Serial number 304 can be shown on calibration card 100. Serial number 304 can be a serial number for calibration card 100 denoting the card type and version. Serial number 304 can help diagnose issues and provide a record of which specific version of calibration card 100 was used in a given test when calibrating vision system 402 with calibration card 100.

Part identifier 306 can help identify a corresponding part for a given component. Part identifier 306 can be a marking which identifies a component. This can be useful during calibration since the subsequent readings in vision system 402 can include component identifier 306 to facilitate reporting of errors, rejections, malformed product, or otherwise, which can be detected by a third party vision system solution. Part identifier 306 can be provided on calibration card 100, or in the field of view of the vision system but apart from calibration card 100. In most preferred embodiments, part identifier 306 can be on calibration card 100. In some possible embodiments, part identifier 306 can be calibration verification image 300, where calibration verification image 300. Part identifier 306 can be marked upon calibration card 100. In most preferred embodiments, part identifier 306 can be displayed below calibration verification image 300 and not adjacent to size marking 102. A benefit of part identifier 306 not being adjacent to size marking 102 is to avoid correlating a part with size marking 102 with new users.

Vendor information 308 can be shown on calibration card 100.

FIG. 4 is a schematic diagram of a distorted view of another possible embodiment of the present invention.

Distorted view 400 is shown in FIG. 4, with calibration card 100, size marking 102, space gap 106, calibration verification image 300, serial number 304, part identifier 306, vision system 402, and lens 404.

Distorted view 400 can refer to the perspective of a vision system to calibration card 100. Distorted view 400 can refer to both distorted view 400 (FIG. 4) and angled view 600 (FIG. 6). In some possible embodiments, vision system 402 can view calibration card 100, or a portion thereof, not limited to size markings 102. In some possible embodiments, distorted view 400 can have calibration verification image 300. Distorted view 400 can refer to an image captured by vision system 402 via lens 404. There can be a distorted view 400 affecting size marking 102, or calibration verification image 300. In a possible embodiment, size marking 102 can be in a first distorted view 400, followed by a second distorted view 400 showing calibration verification image 300 with substantially similar distortion to the first distorted view. Since many vision system applications are in a fixed position, calibration card 100 can be moved while distorted view 400 affects the same image. A benefit of having vision system 402 in the same position can be to help maintain roughly similar distortion of each subsequent image, whether size marking 102 for initial size calibration, proof of calibration via calibration verification image 300, or analysis of a physical part in view of vision system 402 after calibration is performed. Pincushion deformation can result from lens 404 being concave or convex, or due to lens barrel distortion.

Vision system 402 can be a camera. Vision system 402 can include any machine vision system. Vision system 402 can have programmable parameters. Vision system 402 can have an imager.

Lens 404 can cause vision system 402 to skew or distort any element shown on card 100, by way of non-limiting illustration: calibration verification image 300 and size markings 102. It shall be understood that lens 404 can refer to a substantially transparent material through which a photographic image can be captured. Thus, a lens barrel can include lens 404.

Working distance 406 can be a distance between lens 404 and a focal point. The focal point can be at calibration card 100. Working distance 406 can vary by lens size and target area. By way of non-limiting illustration, in a 30 mm wide target field of view, there can be a 12.5 mm lens and a 75 mm working distance.

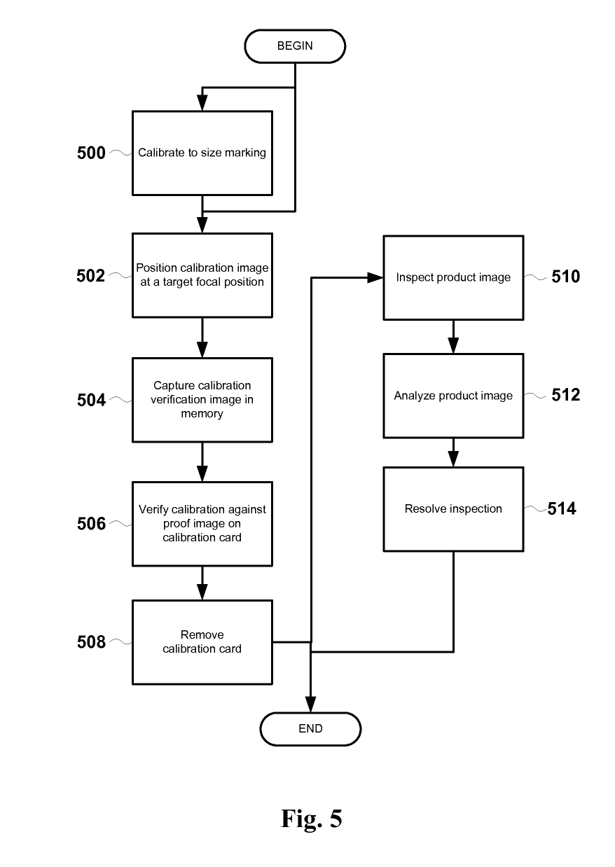

FIG. 5 is a method diagram of a possible embodiment of the present invention.

Calibrate to size marking 500 is shown in FIG. 5, with position card 502, capture 504, verify 506, remove card 508, inspect product image 510, analyze product image 512, resolve inspection 514.

Calibrate to size marking 500 can include focusing vision system 402 to perceive size marking 102 and calibration verification image 300 on calibration card 100, simultaneously or in succession in any order. Lighting, focus, position in relation to the target, exposure time, and aperture can be adjusted. Many activities can be performed during this setup stage. At this point, card 100 is not yet being used. In an embodiment, setup image can include, by way of non-limiting illustration, positioning a physical target, such as a product, component, or label, in view of vision system 402. In a possible embodiment, calibration card 100 can be in view of vision system 402 by having the size marking 102 in view first, calibrating to the size marking, then capturing calibration verification image 300.

Position card 502 can refer to positioning calibration card 100 at a target focal position. Position card 502 can simply prepare to capture calibration verification image 300. A benefit of positioning card 502 card 100 can be to prepare for subsequent product inspection, after first calibrating size 500 and secondly calibration verification image 300. It will be understood that periodic recalibration may be necessary as the environment may degrade the ability for accurate vision system inspection. A benefit of the present invention can be to facilitate calibrating vision system 402 and after time passes, later recalibrating vision system 402 to the same calibration standard via the same calibration card 100 with the same size markings 102 and calibration verification image 300, which can enhance manufacturing repeatability over time.

Capture 504 can refer to capturing calibration verification image 300. Capture 504 can be any in-memory or digital record of calibration verification image 300 with vision system 402. A benefit of capture 504 Calibration card 100 can be positioned in view of vision system 402 for capturing 500. Capture 502 can refer to storing in memory calibration verification image 300 as detected by vision system 402. Memory can be random access memory, or written to digital media. It shall be understood that calibration verification image 300 can be stored internally or externally to vision system 402 for subsequent comparison in subsequent inspection of a part—the later image of a manufactured component or product that comes into view of vision system 402. One of ordinary skill in the art would known how to place calibration card 100 in front of vision system 402 such that vision system 402 can store calibration verification image 300 in memory for later inspection.

Verify 506 can refer to verifying calibration verification image 300. Verify 506 can include checking the calibration verification image 300 against the prior calibration to size markings 500. Verify 506 can be done internally within via vision system 402 to check whether a 1 mm distance in calibration verification image 300 as observed via vision system 402 is consistent with, as a non-limiting example, size markings 102 having 1 mm grid squares. A benefit of verifying 506 can be to use calibration verification image 300 as a proof image, for example, before actual mass-manufacturing product inspection occurs. Verify 506 can refer to running a native subroutine on a vision system to set the vision system 402 to correspond with size markings 102. In an embodiment, pixels can be matched up with the known 1 mm size markings to verify 506. Verify 506 can refer to determining pixel correspondence ratios from the image of size markings 102 as captured by vision system 402 through lens 404. In a preferred embodiment, given that many vision systems 402 have limitations as to the resolution that can be observed, the size markings 102 and calibration verification image 300 on card 100 should be more accurate than the resolution of vision system 402; thus, a benefit can be to facilitate accuracy in vision system 402 when verification 506 is performed. In an embodiment, a manufactured calibration card 100 can be created within, for example, 20 micron accuracy. Errors beyond that tolerance, plus or minus 20 microns, permits vision system 402 to have a measure of reliability when used in conjunction with calibration card 100. By way of non-limiting illustration, verify 506 can coordinate a stored image to a skewed, distorted image. In a possible embodiment, verify 506 can include taking an image record, such as a bitmap, jpeg, gif, png, or proprietary format of at least some portion of calibration card 100 showing at least one size marking 102. In a possible embodiment, verify 506 can include a programmatic input to vision system 402 to recognize size marking 102 in vision system 402, and then to coordinate a scaling scheme for all subsequent measurement in the image based on the specified dimensions of calibration verification image 300, measurement indicator 302, serial number 304, part identifier 306, alone or in or any combination thereof. Vision system 402 when used in reference to verify 506 can refer to smart cameras or non-smart cameras with external memory or external processors that receive images from the non-smart camera. This can include correction for distortion, skew, or other image warping. Some vision systems 402 can inspect an image and analyze it based on an isosceles triangle. Verify 506 can include determining orientation based on orientation indicator 102. Verify 506 can be done in part based on a center point or origin.

Remove card 508 can refer to omitting, moving, or otherwise repositioning calibration card 100 from the view of vision system 402 such that a product can be run or other testing or configuration can be performed. Removing card 508 can include at least some physical movement of calibration card 100 to a position other than any prior position, or movement of vision system 402 such that calibration card 100 is not in the same view. Remove card 508 card 100 can include be sliding calibration card 100 to one side such that calibration verification image 300 is at the focal point instead of size markings 102. Remove card 508 can also include entirely moving calibration card 100 out of the field of view of vision system 402.

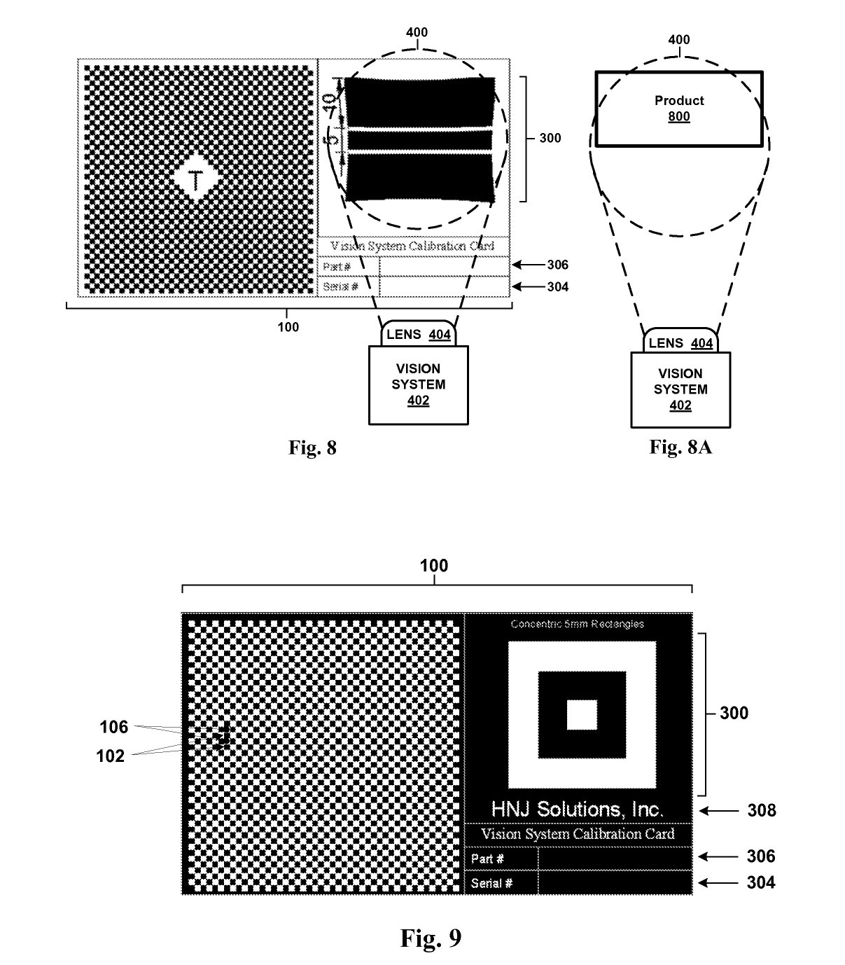

Inspect product image 510 can refer to observing in vision system 402 a product, label, or component, or absence thereof, in view of vision system 402. Product image 800 (FIG. 8A) may be subject to the same distortions where non-limiting examples are shown in FIGS. 4, 6, and 7. In an embodiment, inspect product image 510 can include analyzing 512 and resolving 514 the given product image against calibration verification image 300, or via any of processes 500-508.

Analyze product image 512 can refer to part of inspecting 510. Analyze product image 512 can correlate calibration verification image 300 as stored in vision system 402 with the product inspected by vision system 402. It shall be understood that the term product when used in reference to analyze 512 can be any image, including any physical item which can be the subject of a photograph, and the product can be seen through lens 404. In some embodiments, analyze 512 can be rapid non-human computer-processed inspection via a computer program embodied in vision system 402, to determine whether the product as seen through vision system 402 conforms to calibration verification image 300. Analyze 512 can include, by way of non-limiting illustration, detecting a defect, creating a log, logging a defect in the log, reporting a defect, logging a digital image, displaying a log, triggering a notification message, or reporting a defect.

Resolve 514 can refer to generating a pass signal or a fail signal as the result of inspection 510 or analysis 512. Multiple signals can be generated simultaneously, as multiple test conditions can be imposed for a given inspection, and thus some pass and some fail signals can be sent in relation to a particular product inspection. By way of non-limiting illustration, resolving 514 can provide a resolution of a product based on calibration verification image 300.

FIG. 6 is a skewed angle view of a possible embodiment of the present invention.

Angled image 600 is shown in FIG. 6.

Angled image 600 refers to the perspective of vision system 402 when calibration card 100 is not planar to vision system 402. In lay terms, calibration card 100 is shown “not flat” from the view of vision system 402. A benefit of calibration card 100 is to provide a basis for measurement at an angle, for example, if the product measured after calibration is also displayed at the same angle as the calibration verification image 300 in angled view 600.

Calibration card 100 is shown in FIG. 6 with calibration verification image 300 shown as concentric 2 mm rings. By way of non-limiting illustration, an inspection application can provide concentric rings to verify shapes that look like concentric rings under a smart camera, i.e. vision system 402. Calibration verification image 300 need not be limited to concentric shapes.

FIG. 7 is a lens-distorted image of a possible embodiment of the present invention.

Lens-distorted image 700 is shown in FIG. 7 at an angle (FIG. 6) from the machine vision system.

Lens-distorted image 700 can refer to the distortion of calibration card 100 in general. Since camera lenses vary in shape, being flat, concave, convex, or any combination thereof, a captured image of calibration card 100 through vision system 402 can be warped (FIGS. 4, 6, and 7), even when vision system 402 directly faces calibration card 100.

In some embodiments wherein vision system 402 receives lens-distorted image 700, a benefit of calibration card 100 is to provide a basis for measurement despite lens-distorted image 700, including calibration verification image 300 in distorted view 700. Thus, where the product is viewed in distorted form through a lens, as in lens-distorted view 700, calibration card 100 can still aid in inspection of parts during any manufacturing process. For example, if a top-down view of a bottle is shown in calibration verification image 300 in the form of concentric circles, calibration verification image 300 can provide a basis for verification or inspection.

FIG. 8 is a possible embodiment of the present invention with distorted view of calibration image.

Calibration verification image 300 is shown in FIG. 8 in distorted view 400 seen through lens 404. A benefit of calibration verification image 300 in distorted view 400 is to provide a proof of calibration specified by the dimensions set forth in calibration card 100. Unlike conventional calibration targets in the related art, calibration verification image 300 in distorted view can be provided on the same card 100. A benefit of the present invention is to provide slidability along a conveyor belt to simulate product manufacturing. In a possible embodiment, size marking 102 can provide an initial basis of size calibration, calibration verification image 300 can provide a proof of calibration following size calibration, and then vision systems manufacturing inspection processes can proceed. In another possible embodiment, after a vision system process has been established, to recalibrate the system, the present invention can enhance rapid calibration in conjunction with a pre-stored program.

FIG. 8A is a possible embodiment of the present invention with product image 800.

FIG. 9 is a possible embodiment of the present invention with concentric rectangles. Calibration card 100 is shown in FIG. 9 with calibration verification image 300 shown as concentric 5 mm rectangles which can be seen as being formed by a series of lines at 90 degree angles.

### Conclusion

In summary, the present invention provides a system for machine vision image calibration, comprising a calibration card, a size marking on the calibration card, and a calibration image on the calibration card.

What is claimed is:

1. A system for machine vision image calibration, comprising:
a calibration card;
a size marking on the calibration card; and
a calibration verification image on the calibration card.

2. the system of claim 1, further comprising a plurality of size markings on the calibration card.

3. the system of claim 1, further comprising an orientation indicator on the calibration card.

4. the system of claim 2, where the orientation indicator is positioned centrally to a plurality of size markings, the plurality of size markings comprising the size marking.

5. the system of claim 1, wherein the calibration verification image comprises a pair of concentric circles.

6. the system of claim 1, wherein the calibration verification image comprises a pair of concentric rectangles.

7. the system of claim 1, where the calibration verification image corresponds to a product image drawn to scale.

8. the system of claim 1, where a first line and a second line are parallel and are spaced apart according to a measurement indicator shown on the card.

9. the system of claim 1, wherein the calibration verification image comprises a first shape indicator.

10. the system of claim 1, where the plurality of size markings further comprises a space gap.

11. the system of claim 1, further comprising a part identifier and a serial number.

12. the system of claim 8, wherein the calibration verification image further comprises a second shape indicator.

13. A method for machine vision image calibration, comprising:
calibrating a vision system to a size marking;
capturing a calibration verification image; and
verifying the calibration verification image based on the size marking.

14. the method of claim 13, where the size marking and the calibration verification image are on a calibration card capable of being viewed via a vision system.

15. the method of claim 14, further comprising: inspecting a product image.

16. the method of claim 15, where the calibration verification image corresponds to the product image.

17. the method of claim 16, further comprising: generating a pass signal.

18. the method of claim 15, where the calibration verification image does not correspond to the product image.

19. the method of claim 18, further comprising: generating a failure signal.

20. A machine vision calibration system, comprising:
a vision system comprising a lens;
a first calibration parameter programmed in the vision system;
a calibration card comprising:
a size marking, and
a calibration image;
where the calibration image is shown on the calibration card and received by the vision system;
where the calibration image substantially corresponds to at least some portion of a product;
where the size marking does not bear similarity to the at least some portion of the product; and
where the calibration image is drawn to scale in relation to the product.
